(19) United States
(12) Patent Application Publication
(10) Pub. No.: US 2012/0323754 A1
(43) Pub. Date: Dec. 20, 2012

(54) APPARATUS AND METHODS FOR USE IN THE SALE AND PURCHASE OF ENERGY

(76) Inventors: Jesus Acosta-Cazaubon, Atlanta, GA (US); Paul Michael Kienitz, Kennesaw, GA (US)

(21) Appl. No.: 13/163,415

(22) Filed: Jun. 17, 2011

(51) Int. Cl. G06Q 40/00

(52) U.S. Cl. 705/37

(57) ABSTRACT

A computing device for use with a power system is provided. The computing device includes a communication interface that is configured to receive energy data from at least one utility, wherein the energy data includes at least one of at least one quantity of energy and at least one energy price. A processor is coupled to the communication interface and programmed to generate at least one offer to purchase energy based on the energy data. A user interface is coupled to the processor and configured to enable at least one operator of at least one energy source to sell energy to the utility by responding to the offer to purchase energy.

### BACKGROUND OF THE INVENTION

The field of the invention relates generally to power systems and, more particularly, to a computing device that enables the sale and purchase of energy for use with a power system.

The combination of the increasing world population and the increased use of electric vehicles has created an increased electricity energy demand. Energy demand has also increased for use to power buildings, homes, and/or to charge batteries or other energy sources used in electric vehicles. The demand on the power grid has increased as the cost of fuel has increased. Such demands will likely cause an increase in the price of energy from the power grid. In particular, initially at least, the price of energy is likely to increase during peak times of high demand.

Currently, at least some known utility companies use demand response to manage the consumption of energy by their customers in response to supply conditions. For example, at least some known utility companies may have customers reduce their consumption at critical times and/or in response to market prices. To better manage their customers, at least some known utility companies may use smart grid applications that provide time-based pricing that enables customers to selectively adjust their usage to take advantage of fluctuating prices. Moreover, some known utility companies may provide information, regarding their fluctuating prices for example, to customers using various notification methods, such as e-mails and/or text messages.

In addition, more renewable energy and storage options are generally available online via a network that enables grid operation centers and/or utilities to have access to additional energy sources that may be owned and/or operated by individuals. Such energy sources may include electric vehicle batteries, wind turbines, solar panels, and/or generators. Currently, however, consumers have very little ability to negotiate and/or to sell power, at a relatively competitive rate, from their energy sources back to a grid and/or a utility.

### BRIEF DESCRIPTION OF THE INVENTION

In one embodiment, a computing device for use with a power system is provided. The computing device includes a communication interface that is configured to receive energy data from at least one utility, wherein the energy data includes at least one of at least one quantity of energy and at least one energy price. A processor is coupled to the communication interface and programmed to generate at least one offer to purchase energy based on the energy data. A user interface is coupled to the processor and configured to enable at least one operator of at least one energy source to sell energy to the utility by responding to the offer to purchase energy.

In another embodiment, a power system is provided. The power system includes at least one energy source that is configured to supply energy to a power grid and at least one computing device that is coupled to the energy source. The computing device includes a communication interface that is configured to receive energy data from at least one utility, wherein the energy data includes at least one of at least one quantity of energy and at least one energy price. A processor is coupled to the communication interface and programmed to generate at least one offer to purchase energy based on the energy data. A user interface is coupled to the processor and configured to enable at least one operator of at least one energy source to sell energy to the utility by responding to the offer to purchase energy.

In yet another embodiment, a method for use in the sale and purchase of energy is provided. The method includes receiving, via a communication interface, energy data from at least one utility, wherein the energy data includes at least one of at least one quantity of energy and at least one energy price. At least one offer to purchase energy is generated, via a processor, wherein the offer to purchase energy is based on the plurality of energy prices. A response from at least one operator of at least one energy source is received to the offer to purchase energy, via a user interface, such that the operator is enabled to sell energy to the utility.

### BRIEF DESCRIPTION OF THE DRAWINGS

FIG. 1 is a block diagram of an exemplary power system; and

FIG. 2 is a block diagram of an exemplary computing device that may used with the power system shown in FIG. 1.

### DETAILED DESCRIPTION OF THE INVENTION

The exemplary systems and methods described herein overcome at least some known disadvantages of known power systems by providing a platform that enables operators and/or owners of energy sources to negotiate, and/or to sell power, at a relatively competitive rate, from their own energy sources back to a grid and/or a utility. More specifically, the embodiments described herein provide a computing device for use with a power system. The computing device includes a communication interface that is configured to receive energy data from at least one utility, wherein the energy data includes at least one of at least one quantity of energy and at least one energy price. A processor is coupled to the communication interface and programmed to generate at least one offer to purchase energy based on the energy data. A user interface is coupled to the processor and configured to enable at least one operator of at least one energy source to sell energy to the utility by responding to the offer to purchase energy.

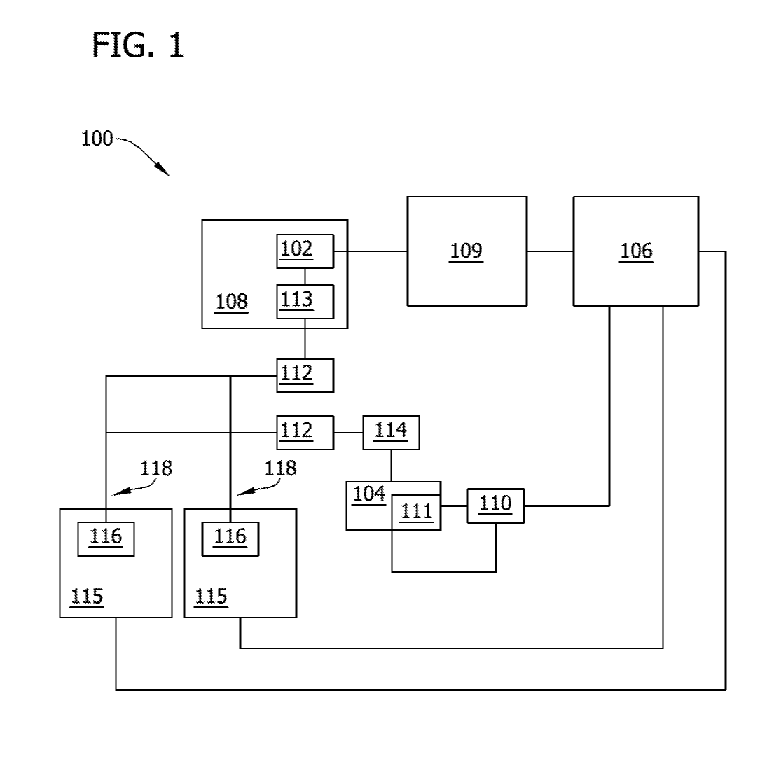

FIG. 1 is a block diagram of an exemplary power system 100. In the exemplary embodiment, power system 100 includes at least one energy source, such as energy source 102 and energy source 104, wherein energy source 102 and energy source 104 are each configured to supply power to a power grid 106. Energy source 102, in the exemplary embodiment, is an energy storage device, such as a battery. More specifically, in the exemplary embodiment, energy source 102 may be battery that may be coupled within or to an electric vehicle 108. In the exemplary embodiment, energy source 102 is a rechargeable lithium-ion battery. Alternatively, energy source 102 may be any other lithium-based battery or any other type of battery that enables power system 100 to function as described herein. Energy source 102 is coupled to an electric vehicle charging station 109, and charging station 109 is coupled to power grid 106. Moreover, energy source 104, in the exemplary embodiment, is an energy generating device, such as a wind turbine, a solar panel, and/or a fuel cell. Energy source 104 is coupled to a generator 110 that is coupled to power grid 106. Alternatively, energy source 104 may be coupled directly to power grid 106. Energy source 104 may also include a battery 111 that is coupled to a convertor (not shown) and/or a transformer (not shown), wherein the convertor is coupled to generator 110. Alternatively, battery 111 may be coupled to the convertor, wherein the convertor is coupled directly to power grid 106.

It should be noted that, as used herein, the term “couple” is not limited to a direct mechanical, electrical, and/or communication connection between components, but may also include an indirect mechanical, electrical, and/or communication connection between multiple components.

Moreover, it should be noted that the term “electric vehicle” refers generally to a vehicle that includes one or more electric motors (not shown) that are used to provide propulsion to the vehicle. Energy, such as electrical energy, used to generate power and propel electric vehicles may come from various sources, such as, but not limited to, an on-board rechargeable battery and/or an on-board fuel cell. In one embodiment, the electric vehicle is a hybrid electric vehicle, which captures and stores energy generated by braking Moreover, a hybrid electric vehicle uses energy stored in an electrical source, such as a battery, to continue operating when idling to conserve fuel. Some hybrid electric vehicles are capable of recharging the battery by plugging into a power receptacle, such as a general power outlet. Another example of an electric vehicle is a fuel-cell vehicle, which uses only electrical energy for propulsion. Accordingly, the term “electric vehicle” as used herein may refer to a hybrid electric vehicle, a fuel-cell vehicle, or any other vehicle to which electrical energy may be delivered via a power grid, such as power grid 106.

In the exemplary embodiment, power system 100 includes at least one computing device 112. More specifically, in the exemplary embodiment, power system 100 includes two computing devices 112 such that each energy source 102 and energy source 104 are each coupled to one computing device 112. Alternatively, power system 100 may include any number of computing devices 112 that enables system 100 to function as described herein. Moreover, in the exemplary embodiment, energy source 102 is coupled to a communication module 113 and energy source 104 is coupled to a communication module 114. Modules 113 and 114 enable energy source 102 and energy source 104, respectively, to communicate with their respective computing device 112. For example, modules 113 and 114 may enable energy sources 102 and 104, respectively, to transmit various information regarding energy sources 102 and 104 to respective computing device 112, such as the energy capacity within each energy source 102 and 104 and/or the amount of energy contained within each energy source 102 and 104 to respective computing device 112.

Each computing device 112 is also coupled to at least one utility 115. In the exemplary embodiment, each computing device 112 is coupled to two utilities 115 such that at least one owner and/or operator of each energy source 102 and/or energy source 104 is enabled to communicate with each utility 115. More specifically, each computing device 112 enables the operator of energy source 102 and/or the operator of energy source 104 to purchase energy from each utility 115 and/or sell energy from energy source 102 and/or energy source 104 to each utility 115. In the exemplary embodiment, owner and/or operator may include an individual owner and/or operator and/or a cooperative group of owners and/or operators.

In the exemplary embodiment, each utility 115 includes a network interface 116 that is coupled to a network 118 to enable each utility 115 to communicate with each computing device 112. In the exemplary embodiment, each utility 115 may communicate with at least one of computing devices 112 using a wired network connection (e.g., Ethernet or an optical fiber), a wireless communication means, such as radio frequency (RF), e.g., FM radio and/or digital audio broadcasting, an Institute of Electrical and Electronics Engineers (IEEE®) 802.11 standard (e.g., 802.11(g)) or 802.11(n)), the Worldwide Interoperability for Microwave Access (WIMAX®) standard, a cellular phone technology (e.g., the Global Standard for Mobile communication (GSM)), a satellite communication link, and/or any other suitable communication means. WIMAX is a registered trademark of WiMax Forum, of Beaverton, Oreg. IEEE is a registered trademark of the Institute of Electrical and Electronics Engineers, Inc., of New York, N.Y. In the exemplary embodiment, for example, each utility 115 may be configured to transmit energy data, such as at least one quantity of energy (watts) and/or at least one energy price to each computing device 112, wherein each energy price may be associated with certain limitations, such as, for example, a time range, a duration of time, quantity of energy, and/or operating ranges of energy sources, such as energy source 102 and/or energy source 104. Certain limitations may also include weather conditions, grid status, such as an outage or gird capacity. Alternatively, utility 115 may be configured to transmit any other information to each computing device 112 that enables power system 100 to function as described herein.

During operation, an operator of an energy source, such as energy source 102 and/or energy source 104, couples each energy source 102 and 104 to power grid 106. For example, an operator of energy source 102 may couple energy source 102 to charging station 109 such that energy source 102 is coupled to power gird 106. Similarly, an operator of energy source 104 may couple energy source 104 and or battery 111 to generator 110 and/or to power grid 106 such that energy source 104 is coupled to power grid 106. A signal representative of energy source 102 being coupled to power grid 106 is transmitted from energy source 102 to respective computing device 112 via communication module 113. Similarly, a signal representative of energy source 104 being coupled to power grid 106 is transmitted from energy source 104 to respective computing device 112 via communication module 114. Each computing device 112 may then prompt each operator with an option to receive energy data, such as, for example, a plurality of energy prices and/or a quantity of energy, from each utility 115. The operator who elects to receive such information confirms receiving the energy data, and computing device 112 presents the energy data to the operator. By receiving the energy data, the operator may identify when to purchase energy from each utility 115 and/or when to sell energy to each utility 115.

In the exemplary embodiment, each operator chooses to sell energy to each utility 115 and inputs such information into the respective computing device 112. Each computing device 112 transmits a signal to each utility 115. Energy from energy source 102 is transmitted to charging station 109 and to power grid 106. Similarly, energy from energy source 104 is transmitted to generator 110 and to power grid 106. This additional energy supplied to power grid 106 can later be sold by each utility 115 to others. Alternatively, the operator, such as the operator of energy source 102 may decide to purchase energy from each utility 115, via respective computing device 112. In such a case, energy from power grid 106 may be transmitted to energy source 102 and/or energy source 104.

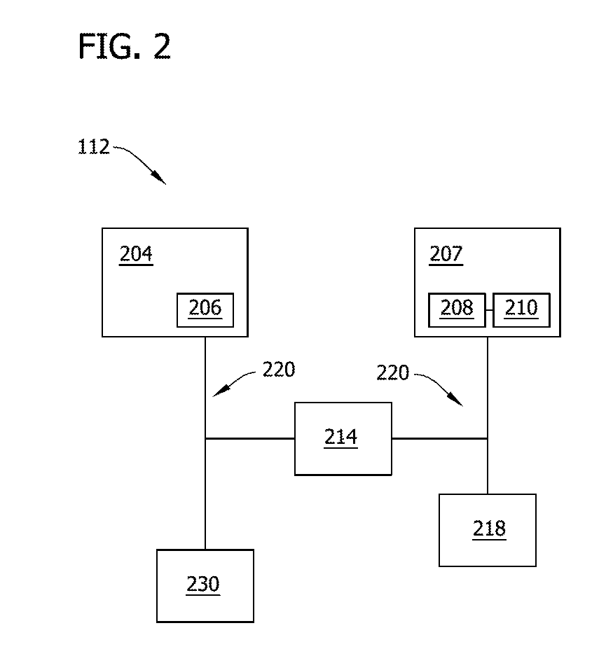

FIG. 2 is a block diagram of one computing device 112 used with power system 100 (shown in FIG. 1). In the exemplary embodiment, computing device 112 includes a user interface 204 that receives at least one input from a user, such as an operator and/or owner of an energy source, such as energy source 102 (shown in FIG. 1) and energy source 104 (shown in FIG. 1). In the exemplary embodiment, user interface 204 includes a keyboard 206 that enables a user to input pertinent information. Alternatively, user interface 204 may include, for example, a pointing device, a mouse, a stylus, a touch sensitive panel (e.g., a touch pad or a touch screen), a gyroscope, an accelerometer, a position detector, and/or an audio input interface (e.g., including a microphone).

Moreover, in the exemplary embodiment, computing device 112 includes a presentation interface 207 that presents information, such as input events and/or validation results, to the user. In the exemplary embodiment, presentation interface 207 includes a display adapter 208 that is coupled to at least one display device 210. More specifically, in the exemplary embodiment, display device 210 is a visual display device, such as a cathode ray tube (CRT), a liquid crystal display (LCD), an organic LED (OLED) display, and/or an “electronic ink” display. Alternatively, presentation interface 207 may include an audio output device (e.g., an audio adapter and/or a speaker) and/or a printer.

Computing device 112 also includes a processor 214 and a memory device 218. In the exemplary embodiment, processor 214 is coupled to user interface 204, presentation interface 207, and to memory device 218 via a system bus 220. In the exemplary embodiment, processor 214 communicates with the user, such as by prompting the user via presentation interface 207 and/or by receiving user inputs via user interface 204. Moreover, in the exemplary embodiment, processor 214 is programmed by encoding an operation using one or more executable instructions and providing the executable instructions in memory device 218. For example, processor is programmed to generate at least one offer to purchase energy from an operator of an energy source, such as energy source 102 and/or energy source 104. The offer to purchase energy is based on the energy data that computing device 112 receives from each utility 115 (shown in FIG. 1). Processor 214 is further programmed to generate at least one offer for sale of energy to the operator of energy source 102 and/or energy source 104. The offer for sale of energy is also based on the energy data received from utility 115.

In the exemplary embodiment, processor 214 may also be programmed to organize the energy data in a hierarchy. In the exemplary embodiment, processor 214 may be programmed to organize a plurality of energy prices and/or a plurality of quantities of energy received from each utility 115 in a hierarchy. For example, processor 214 may be programmed to organize a highest energy price of the plurality of energy prices in a first tier within the hierarchy and a lowest energy price of the plurality of energy prices in a last tier within the hierarchy. Similarly, processor 214 may be programmed to organize a highest quantity of energy in a first tier within the hierarchy and a lowest quantity of energy in a last tier within the hierarchy. Alterantively, processor 214 may be programmed to organize the energy data using any criteria that may be programmed to processor. Such criteria, for example, may be established by the operator.

The term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, memory device 218 includes one or more devices that enable information, such as executable instructions and/or other data, to be stored and retrieved. Moreover, in the exemplary embodiment, memory device 218 includes one or more computer readable media, such as, without limitation, dynamic random access memory (DRAM), static random access memory (SRAM), a solid state disk, and/or a hard disk. In the exemplary embodiment, memory device 218 stores, without limitation, application source code, application object code, configuration data, additional input events, application states, assertion statements, validation results, and/or any other type of data. More specifically, in the exemplary embodiment, memory device 218 stores input data received by an operator via user interface 204 and/or information received from other components of power system 100, such as from utility 115.

Computing device 112, in the exemplary embodiment, also includes a communication interface 230 that is coupled to processor 214 via system bus 220. Moreover, in the exemplary embodiment, communication interface 230 is communicatively coupled to utility 115 via network 118 (shown in FIG. 1) and communicatively coupled to communication module 113 (shown in FIG. 1) and communication module 114 (shown in FIG. 1). In the exemplary embodiment, communication interface 230 may communicate with utility 115, energy source 102, energy source 104, and/or other components within power system 100.

During operation, an operator of an energy source, such as energy source 102 and/or energy source 104, couples each energy source 102 and 104 to power grid 106. For example, an operator of energy source 102 may couple energy source 102 to charging station 109 such that energy source 102 is coupled to power gird 106. Similarly, an operator of energy source 104 may couple energy source 104 and/or battery 111 to generator 110 and/or to power grid 106 such that energy source 104 is coupled to power grid 106.

A signal representative of energy source 102 being coupled to power grid 106 is transmitted from energy source 102 to respective computing device 112 via communication module 113. Similarly, a signal representative of energy source 104 being coupled to power grid 106 is transmitted from energy source 104 to respective computing device 112 via communication module 114. Communication interface 230 in each computing device 112 receives the signal and the signal is transmitted to processor 214 in each computing device 112. Presentation interface 207 in each computing device 112 then prompts each operator with an option to receive the energy data from each utility 115. In the exemplary embodiment, each operator provides an input, via user interface 204 in each computing device 112, to receive the energy data.

Processor 214 then transmits a signal to communication interface 230 to retrieve the information from each utility 115. Each utility 115 transmits the energy data to each computing device 112 via network 118. When communication interface 230 receives the information, the energy data is transmitted to processor 214. In the exemplary embodiment, processor 214 rank orders the energy data. For example, processor 214 may organize a plurality of energy prices and/or a plurality of quantities of energy received from each utility 115 in a hierarchy. Processor 214 may also organize a highest energy price of the plurality of energy prices in a first tier within the hierarchy and a lowest energy price of the plurality of energy prices in a last tier within the hierarchy.

Computing device 112 presents the energy data to each operator via presentation interface 207 for each computing device 112. By receiving the energy data from each utility 115, each operator is enabled to identify when to purchase energy from each utility 115 and when to sell energy to each utility 115. For example, each operator may identify a time range when energy prices are low and a time range when energy prices are high. Moreover, an operator may want to sell energy to utility 115 during the time range when energy prices are high and purchase energy from utility 115 when energy prices are low.

When each operator has been presented with the energy data, processor 214 in each computing device 112 generates at least one offer to purchase energy from each operator and/or generates at least one offer for sale of energy to each utility 115. Computing device 112 then presents each operator, via presentation interface 207, with the offer to purchase energy and/or with the offer for sale of energy. In the exemplary embodiment, each operator inputs a response to accept the offer to purchase energy such that each utility 115 is enabled to purchase energy from each operator. Computing device 112 transmits a signal representative of each operators' response to each utility 115 notifying each utility 115 of the acceptance.

Alternatively, based on the energy data of each utility 115 that is presented to each operator, each operator may also input to sell energy to only one utility 115. For example, if the energy prices in the energy data for one utility 115 are higher than the energy prices in the energy data for another utility 115, the operator may decide to sell only to the utility 115 with the higher energy prices. Such a selection by the operator may be transmitted from computing device 112 to each utility 115. When each utility 115 receives the operator's selection, the utility 115 not selected due to, for example, a lower price, may be willing to increase their price and transmit the new price to computing device 112. Computing device 112 may then present the new price to each operator enabling the operator to change his or her selection by an input via user interface 204.

In the exemplary embodiment, when an input is made that each operator is selling energy to each utility 115, communication module 113 then transmits the amount of energy contained within energy source 102 to respective computing device 112. Similarly, communication module 114 transmits the amount of energy contained within energy source 104 and/or production level or continuous supply level of energy source 104 to respective computing device 112. When computing device 112 receives the amount of energy in each energy source 102 and 104, computing device 112 prompts, via presentation interface 207, each operator to provide a duration of time for which energy will be transmitted from each energy source 102 and energy source 104 to power grid 106. Alternatively, computing device 112 may prompt each operator to provide an amount of energy that will be transmitted from each energy source 102 and 104 to power grid 106. Each operator then inputs, via user interface 204, for example, the duration of time for which energy will be transferred from each energy source 102 and energy source 104. Energy is then transmitted from each energy source 102 and 104 to power grid 106.

Moreover, in the exemplary embodiment, when each operator is presented with the offer to purchase energy and/or with the offer for sale of energy, each operator may input a response to accept the offer for sale of energy such that each utility 115 is enabled to sell energy to each operator. For example, the operator of energy source 102 may input a response to accept the offer for sale of energy. In the exemplary embodiment, the operator may select and purchase energy from utility 115 providing the lowest energy prices. Alternatively, the operator may select and purchase energy from utility 115 providing the greatest quantity of energy.

Further, in the exemplary embodiment, when the operator chooses the best rate and/or any other parameter that the operator establishes for the purchase of energy from one of the utilities 115, computing device 112 will prompt the operator, via presentation interface 207, to provide, for example, a duration of time for which each energy source 102 will receive energy from power grid 106. Alternatively, computing device 112 may prompt the operator to provide a quantity of energy that will be transmitted from power grid 106 to energy source 102. The operator then inputs, via user interface 204, the duration of time for which energy will be transferred from power grid 106 to energy source 102. Energy is then transmitted to energy source 102 from power grid 106.

As compared to known apparatus, systems, and methods that are used to enable communication between utilities and consumers, the exemplary apparatus, systems, and methods described herein facilitate a platform for operators and/or owners of energy sources to negotiate and sell power, at a relatively competitive rate, from their energy sources back to a grid and/or the utility. More specifically, the embodiments described herein provide a computing device for use with a power system. The computing device includes a communication interface that is configured to receive energy data from at least one utility, wherein the energy data includes at least one of at least one quantity of energy and at least one energy price. A processor is coupled to the communication interface and programmed to generate at least one offer to purchase energy based on the energy data. A user interface is coupled to the processor and configured to enable at least one operator of at least one energy source to sell energy to the utility by responding to the offer to purchase energy.

Exemplary embodiments of the apparatus, systems, and methods are described above in detail. The apparatus, systems, and methods are not limited to the specific embodiments described herein, but rather, components of the apparatus, systems and/or steps of the methods may be utilized independently and separately from other components and/or steps described herein. For example, the system may also be used in combination with other apparatus, systems, and methods, and is not limited to practice with only the system as described herein. Rather, the exemplary embodiment can be implemented and utilized in connection with many other applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computing device for use with a power system, said computing device comprising:
a communication interface configured to receive energy data from at least one utility, wherein the energy data includes at least one of at least one quantity of energy and at least one energy price;
a processor coupled to said communication interface and programmed to generate at least one offer to purchase energy based on the energy data; and
a user interface coupled to said processor and configured to enable at least one operator of at least one energy source to sell energy to the at least one utility by responding to the at least one offer to purchase energy.

2. A computing device in accordance with claim 1, wherein said processor is further programmed to generate at least one offer for sale of energy based on the energy data, the at least one offer for sale enables the at least one operator to selectively purchase energy from the at least one utility.

3. A computing device in accordance with claim 2, wherein said processor is programmed to prompt the at least one operator to input a duration of time for the at least one operator to receive energy when the at least one operator accepts the at least one offer for sale of energy.

4. A computing device in accordance with claim 2, wherein said processor is programmed to receive a response to the at least one offer for sale of energy from a plurality of operators to enable each of the operators to provide a bid on the at least one offer for sale of energy.

5. A computing device in accordance with claim 1, further comprising a presentation interface coupled to said processor for use in presenting the energy data to the at least one operator to enable the at least one operator to identify at least one of when to purchase energy from the at least one utility and when to sell energy to the at least one utility.

6. A computing device in accordance with claim 1, wherein the at least one quantity of energy includes a plurality of quantities of energy and said processor is programmed to rank order the plurality of quantities of energy.

7. A computing device in accordance with claim 1, wherein the at least one energy price includes a plurality of energy prices and said processor is programmed to rank order the plurality of energy prices.

8. A power system comprising:
at least one energy source for supplying energy to a power grid;
at least one computing device coupled to said at least one energy source, said at least one computing device comprising:
a communication interface configured to receive energy data from at least one utility, wherein the energy data includes at least one of at least one quantity of energy and at least one energy price;
a processor coupled to said communication interface and programmed to generate at least one offer to purchase energy based on the energy data; and
a user interface coupled to said processor and configured to enable at least one operator of at least one energy source to sell energy to the at least one utility by responding to the at least one offer to purchase energy.

9. A power system in accordance with claim 8, wherein said at least one energy source comprises at least one of an energy storage device and an energy generating device.

10. A power system in accordance with claim 9, wherein said energy storage device is a battery and said energy generating device is at least one of a wind turbine, a solar panel, a generator, and a fuel cell.

11. A power system in accordance with claim 8, wherein said processor is further programmed to generate at least one offer for sale of energy based on the energy data, the at least one offer for sale enables the at least one operator to selectively purchase energy from the at least one utility.

12. A power system in accordance with claim 11, wherein said processor is programmed to prompt the at least one operator to input a duration of time for the at least one operator to receive energy when the at least one operator accepts the at least one offer for sale of energy.

13. A power system in accordance with claim 11, wherein said processor is programmed to receive a response to the at least one offer for sale of energy from a plurality of operators to enable each of the operators to provide a bid on the at least one offer for sale of energy.

14. A power system in accordance with claim 8, wherein said computing device further comprises a presentation interface coupled to said processor for use in presenting the energy data to the at least one operator to enable the at least one operator to identify at least one of when to purchase energy from the at least one utility and when to sell energy to the at least one utility.

15. A power system in accordance with claim 8, wherein the at least one quantity of energy includes a plurality of quantities of energy and said processor is programmed to rank order the plurality of quantities of energy.

16. A power system in accordance with claim 8, wherein the at least one energy price includes a plurality of energy prices and said processor is programmed to rank order the plurality of energy prices.

17. A method for use in the sale and purchase of energy, said method comprising:
receiving, via a communication interface, energy data from at least one utility, wherein the energy data includes at least one of at least one quantity of energy and at least one energy price;
generating, via a processor, at least one offer to purchase energy based on the energy data; and
receiving a response, via a user interface, from at least one operator of at least one energy source to the at least one offer to purchase energy such that the at least one operator is enabled to sell energy to the at least one utility.

18. A method in accordance with claim 17, further comprising generating, via the processor, at least one offer for sale of energy based on the energy data wherein the at least one offer for sale enables the at least one operator to selectively purchase energy from the at least one utility.

19. A method in accordance with claim 17, further comprising presenting, via a presentation interface, the energy data to the at least one operator to enable the at least one operator to identify at least one of when to purchase energy from the at least one utility and when to sell energy to the at least one utility.

20. A method in accordance with claim 17, further comprising prompting the at least one operator to input a duration of time for the at least one operator to provide energy from the at least one energy source when the at least one operator accepts the at least one offer to purchase energy.
